(19) United States
(12) Patent Application Publication
(10) Pub. No.: US 2020/0336971 A1
(43) Pub. Date: Oct. 22, 2020

(54) SYSTEM AND METHOD TO ACCELERATE WIRELESS BEACON RESPONSE USING PRE-CACHED BEACON ASSOCIATED DATA

(71) Applicants: Robert J. Goldman, San Jose, CA (US); Austen Goldman, San Jose, CA (US); Ellis Goldman, San Jose, CA (US)

(72) Inventors: Robert J. Goldman, San Jose, CA (US); Austen Goldman, San Jose, CA (US); Ellis Goldman, San Jose, CA (US)

(21) Appl. No.: 16/388,655

(22) Filed: Apr. 18, 2019

(51) Int. Cl. H04W 48/12; H04L 29/08

(52) U.S. Cl. CPC H04W 48/12; H04W 84/12; H04L 67/289; H04L 67/2842

(57) ABSTRACT

System and method to enable Bluetooth wireless beacons to trigger immediate playback of large sized files, such as high definition video, on smartphones and other handheld computerized devices. The system is configured to recognize when a device is in proximity of a beacon field comprising a plurality of wireless beacons. The device transmits location information, such as GPS, WiFi, or beacon information to a record server, which identifies the relevant beacon field, and transmits information pertaining to the beacon identifiers and associated beacon linked data records to a memory cache onboard the device. When a user with the device wanders into proximity of a particular wireless beacon, the device detects that beacon identifier, matches the identifier with a data record in memory cache, and can instantly display even large files, such as high definition video. The system can also monitor user interactions and transmit useful data back to the server.

### BACKGROUND OF THE INVENTION

### Description of the Related Art

There has been an extensive amount of interest in providing location based information to users. Some prior art, such as the work of Showers (US patent application 2014/0365304), used geolocation based methods to provide information to users.

Other prior art, such as the art of Hefetz (US patent application 2014/0137199), used geographical proximity to various WiFi locations to help authenticate users of WiFi-equipped handheld computerized devices.

Other prior art, such as Zhu (U.S. Pat. No. 8,965,398), and Mendelson (U.S. Pat. No. 9,204,257), proposed using RF Bluetooth® beacons for mapping applications; the entire contents of these applications are incorporated herein by reference. Indeed, since about 2013, built-in support for use of Bluetooth beacons (using BLE) has been commercially available for both Apple iOS and Android OS handheld computerized devices. Apple provides the iBeacon platform, while Google provides the Eddystone open source beacon format. Various iOS and Android device apps that can detect Bluetooth beacons are also commercially available.

Use of Bluetooth beacons for other types of applications, such as delivering advertising data, has also been proposed by various workers, such as Lee (U.S. Pat. No. 9,906,945) the entire contents of which are incorporated herein by reference.

Despite such prior art, Bluetooth beacons remain a little-used technology and are seldom used either in commerce or for other applications. Nonetheless, the underlying problem, how best to deliver information at the precise time and place when a human user is most likely to find the information to be useful, remains a pressing problem in many areas of technology and commerce.

### BRIEF SUMMARY OF THE INVENTION

As discussed above, although wireless beacons, such as Bluetooth beacons, have been known for a number of years, such beacons have generally met with limited commercial success. The present invention was inspired, in part, by the insight that part of the problem for this limited success is that prior art wireless beacon systems have generally delivered an inadequate user experience.

Prior art beacons tend to operate using a “push” basis. When a smartphone device, running such a Bluetooth beacon app, recognizes a nearby Bluetooth beacon, such apps typically notify the user using push notifications. These, for example, can be short automatic pop up text message or alert. Such push messages have a limited data size, often less than 4 kilobytes. Such push notifications are often considered a nuisance, and thus typically are regularly dismissed or inactivated by users.

The invention is inspired, in part, by the insight that useful and compelling information often requires graphics and even high definition video. Such useful and compelling information may require file sizes well in excess of one megabyte, such as 10 megabytes, 100 megabytes, and perhaps on occasion more than 1000 megabytes (1 gigabyte or more). An improved Bluetooth beacon technology should be able to handle files of this size.

The invention is also inspired, in part, by the insight that wireless network latency (e.g. slow response times) and limited bandwidth are other problems that have tended to greatly restrict the use of this type of technology. Prior art beacons, such as Bluetooth beacons, typically operate by transmitting a wireless beacon identifier, which may comprise a UUID code and/or alternative or additional information, to any device that can receive the information. When a suitable Bluetooth transceiver equipped handheld computerized device, such as an iPhone or Android phone running a suitable Bluetooth beacon detection app, receives this identifier/code, the app must then subsequently connect to a server, such as remote internet server, to do anything useful with this identifier/code. That is, any information, such as data records linked to a particular beacon, will generally reside on this remote server. Over typical wireless network speeds, it takes a significant amount of time to transmit this beacon linked data to the handheld computerized device.

In locations of poor connectivity and/or higher network latency, or when large amounts of data, such as video files, are linked to the beacon, the experience is poor. The time from reading the beacon code to receipt of displayed information can sometimes be measured in minutes, if the data is received at all. The result is that the beacon linked information is received long after it is meaningful or of value. For example, imagine walking past a product (and an associated short-range Bluetooth beacon), in a supermarket but then not receiving any Bluetooth beacon linked product information on your smartphone until you have walked a further 4 aisles away from the product and the beacon.

Using present technology, due to network latency effects and slow transmission speeds, all you may receive, often too late to be useful to you, may be a brief but annoying pop-up message without any compelling graphics or video to go with it. You probably don't receive this message because they are annoying, and you previously disabled pop-up messages in any event.

The invention is thus based, in part, on the insight that a more effective method to use wireless beacons, such as Bluetooth beacons, is to devise systems and methods that pre-load information, such as wireless beacon identifiers and large (e.g. often 100 kilobyte to 1 gigabyte size) data records linked to these wireless beacon identifiers, in advance of any use, and to store this data in a memory cache onboard the memory in the handheld computerized device itself. This way, the large data files, which can even comprise high definition video data, can be instantly available for use as soon as a particular wireless beacon identifier is identified by the system.

To accomplish this goal, however, the invention must also create ways to efficiently store the right type of data in advance and to efficiently clear this data and replace it with more relevant data when the user moves to a new location with a new set of wireless beacons.

Thus, as will be discussed, in some embodiments, the invention may be a system or method (typically a software implemented method) of delivering data to a graphical user interface (GUI) of a handheld computerized device, often an iOS or Android smartphone or tablet type device.

The invention typically uses a plurality of wireless beacons, each disposed at a beacon location within a beacon field, to transmit various wireless beacon identifiers to beacon areas local (e.g. often within a radius of about 0-3 feet, or 3 feet to 30 feet, but sometimes as much as 300 feet) to each beacon location. The invention configures the device (again usually with suitable software, either as an app or as part of the device's operating system software) to receive these wireless beacon identifiers when the device has a location that is within any of these beacon areas. The invention further configures (and as will be described, also loads from a remote server) the device memory with a memory cache comprising a first plurality of data records linked that are linked to these various wireless beacon identifiers. According to the invention, the handheld wireless device is further configured to use its onboard device processor, and the received wireless beacon identifiers, to retrieve those data records linked that are linked to any given received wireless beacon identifiers. The handheld wireless device is typically then configured to display at least some of this data (from the appropriate retrieved data record) on the devices GUI (e.g. typically the device's touchscreen).

### BRIEF DESCRIPTION OF THE DRAWINGS

FIG. 1 shows an overview of a typical handheld computerized device that may be utilized by the invention.

FIG. 2 shows how various wireless beacons may be disposed in various locations within a “beacon field”, as well as an overview of how data records linked to these beacons can be automatically inputted into the memory cache of a handheld computerized device.

FIG. 3 shows how when the handheld computerized device comes within range of a particular wireless beacon, the invention enables the device to almost instantly retrieve that beacon's data records from storage in the memory cache. Thus even large sized files of high-resolution video data can be nearly instantly displayed on the device's screen.

FIG. 4 shows how the invention acts to repopulate the handheld computerized device's memory cache when the device enters a different beacon field. The device can now operate with an entirely new set of beacons and beacon linked data records.

FIG. 5 shows a flow chart illustrating one embodiment of the invention's software. The invention provides software for both handheld computerized devices and record servers, and the two types of software interact in order to keep the handheld computerized device's memory cache updated with appropriate information.

FIG. 6 shows an example of how, according to the invention, the handheld computerized device, after recognizing a beacon associated with a wine exhibit at a beacon field associated with a Walmart store, has now almost instantly retrieved and displayed data records comprising a video and an interactive coupon for this wine. This is an example screenshot of the handheld computerized device's display screen in the process of showing this video and interactive coupon. Note the coupon value varies according to the time elapsed since the coupon was first displayed, and the video first started playing.

FIG. 7 shows another example screenshot showing the Walmart example previously described in FIG. 6. Here more time has elapsed, the video has played further, and the value of the discount coupon has become still higher. This encourages the user to watch the video.

FIG. 8 shows a simple example of the type of statistical analysis that may be done by the system. Here the various wireless beacon linked data records (here various ads, songs, and videos) are ranked according to various criteria.

### DETAILED DESCRIPTION OF THE INVENTION

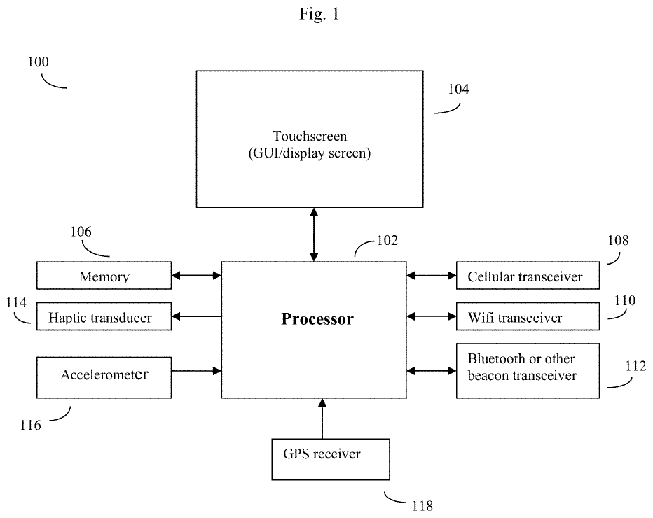

FIG. 1 shows an overview of a typical handheld computerized device (100), such as an iOS or Android smartphone or tablet computer. This type of device will typically comprise a processor (102) (e.g. at least one processor, which may be an ARM, MIPS, x86 or other type processor, often with multiple cores). The device will further comprise at least one touchscreen (104), memory (106) (such as any of Flash, RAM, or other type memory), and one or more wireless cellular (e.g. 3G, 4G, 5G etc.) transceivers (108), one or more wireless WiFi transceivers (110), one or more wireless Bluetooth or other type beacon transceivers or receivers (112), which often may be used to detect the beacons described herein. The device will often also have an accelerometer or other type motion sensor (116), a haptic transducer (114) (e.g. an electromechanical unit that configured to make the device (100) vibrate or twitch), and a global positioning system (GPS) receiver (118) to enable the geographical location of the device to be determined.

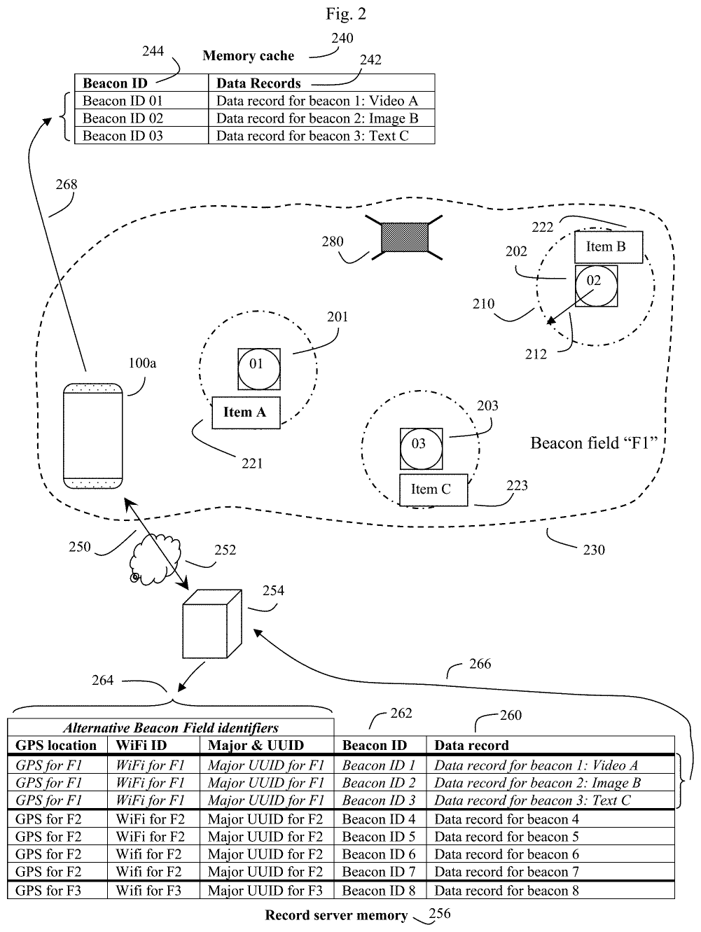

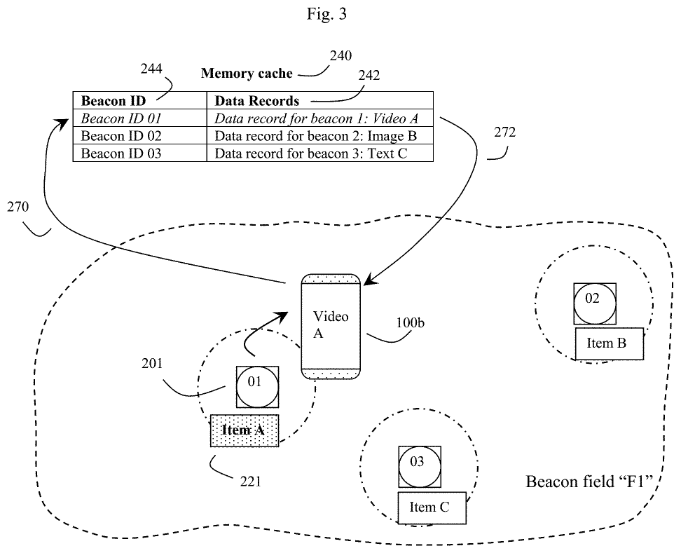

In the following discussion, please refer to FIG. 2 to FIG. 3, as well as FIG. 1.

As previously discussed, in some embodiments, the invention can comprise a system or method of delivering data to a graphical user interface (GUI) (104) of a handheld computerized device (100). As shown in FIG. 3, this method will typically comprise transmitting a plurality of wireless beacon identifiers. This is typically done by using a plurality of wireless beacons (e.g. 201, 202, 203), each disposed at a beacon location within a beacon field (230), each comprising a beacon short-range wireless transmitter configured to transmit a wireless beacon identifier. The wireless beacons transmit these wireless beacon identifiers to beacon areas local (210, 212) to each beacon location.

Although here, the drawings show beacon areas that are circular areas (210) with a radius (212) that is approximately equal to the typical wireless transmission range of that particular beacon, note that in some embodiments, the beacons may transmit in a directional manner, and thus the beacon areas may not always be circular.

Note that the beacon short-range wireless transmitter can comprise any of an RFID transmitter, a Bluetooth wireless transmitter, or a transmitter portion of a Bluetooth wireless transceiver.

The invention can further configure (often by software run by the device processor 102), the device beacon transceiver or receiver (112) to receive wireless beacon identifiers when the device (100) has a device location that is within the beacon areas (see FIG. 3, 100b, which has a device location within the beacon area of beacon 201). As previously discussed, the device will typically detect an omnidirectional wireless beacon when the device has a location that is within the effective radius (212) of wireless transmission of that particular wireless beacon (e.g. under three feet [1 meter], between 3 feet and 30 feet [1-10 meters], or between 30 feet and 300 feet [10-100 meters].

As previously discussed, the device (100) will typically comprise a device processor (102), device memory (106); at least one device transceiver (108, 110, 112); and a GUI (104) such as a touchscreen. The invention typically uses the device processor (102) to configure the device memory (106) to comprise a memory cache (see FIG. 2 240). This memory cache will typically comprise a first plurality of data records (242) linked to the wireless beacon identifiers (244). (The invention's systems and methods for loading this memory cache with these data records and beacon identifiers will be discussed shortly.) According to the invention, the handheld computerized device processor (102) is configured to use these received wireless beacon identifiers to then retrieve those data records (242) that are linked to the appropriate received wireless beacon identifiers. The computerized device is also configured to use the device processor (102) to display at least some this retrieved data from the retrieved data records on the GUI (104).

To further understand how the memory cache (240) is loaded with the correct beacon identification data and the correct beacon identification data linked data records, please refer to FIG. 2.

The invention will typically configure the device (100) to wirelessly transmit (250) (often over a computer network 252), information pertaining to the device's location to a record server (254).

Note that, at least in the context of a record server (254) determining a device (100) location relative to a beacon field (230), the record server can determine the device location in more than one way.

In some embodiments, when the record server knows the geographical coordinates of the beacon field (230), the record server can use the device's geographical location (e.g. GPS coordinates) to determine when the device is located at a particular beacon field.

In some embodiments, when the record server knows the WiFi identification (e.g. SSID) of WiFi access points serving a particular beacon field, the record server can use the device identification of WiFi signals from that identified WiFi access point to determine when the device is located at a particular record field.

In some embodiments, when the record server knows that certain wireless beacons, with associated wireless beacon identifiers, are all within a particular record field, the server can use a reported device identification of some or any of these wireless beacons to deduce that the device is located within a beacon field containing the other wireless beacons known to be within that particular field.

The record server (254) will typically comprise at least one record server processor, record server memory (256), network interface, and often suitable operating system software (e.g. Windows, Linux, Unix, etc.) and memory database software (e.g. SQL based relational database software, non-relational databases such as NoSQL, and the like). Here the figures show a row and column based SQL-like database structure because this is easy to draw and understand, but this example is not intended to be limiting.

The record server memory will typically comprise a second plurality of data records (260) linked to these wireless beacon identifiers (262). The wireless beacon identifiers are further linked according to their beacon field (264), which will be discussed in more detail shortly.

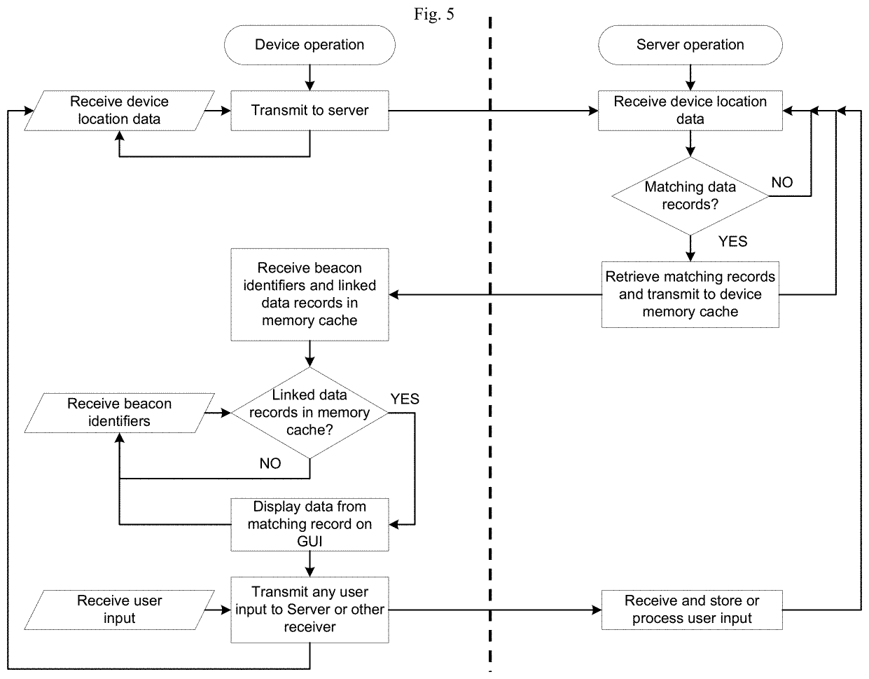

The record server processor is typically configured to match (often by suitable invention server-based software, discussed in more detail in FIG. 5) the information pertaining to the device location with the appropriate beacon field (230, 264). The server processor is also configured to use such matches to direct (or control) the transmission of any matching data records (260) and any linked wireless beacon identifiers (262) to the device (100).

Once this information is received by device (100), and as shown in more detail in FIG. 5, and also as discussed in more detail below, the invention's software, here running on the handheld computerized device (100) is configured to direct the device processor (102) to store these at least some matching data records (260) and linked wireless beacon identifiers (262) in the memory cache (240, 242, 244). Note that as shown in FIG. 2, this “cache loading” can be done when the device (100a) first enterers the beacon field (230), and often even before the device encounters the first item associated wireless beacon (such as 201). As a result, the device's memory cache (240) can often be pre-loaded with the appropriate information (e.g. beacon identifiers, associated data records) so that this information is now available onboard device (100) for instant use when needed.

FIG. 2 shows how according to the invention, various wireless beacons (201, 202, and 203) may be disposed in various locations within a region of space here called the “beacon field” (230). Here assume that each beacon is configured to transmit its own beacon identifier. For simplicity, assume that the beacon identifiers are here only two digits long. Thus assume that the beacon identifier for beacon (201) is “01”, the beacon identifier for beacon (202) is “02”, and the beacon identifier for beacon (203) is “03”, and so on.

These wireless beacons can, for example, comprise a Bluetooth wireless beacon, such as a standard (class 1 with a 100-meter range) or low energy (e.g. class 2, with a 10-meter range, or class 3 with a 1-meter range) Bluetooth wireless beacon. Such Bluetooth beacons often transmit in a frequency range around 2.45 GHz.

Here the term “Bluetooth” is used generically as a term to describe various types of wireless beacons. Note that the systems and methods described herein can function well with other short range (e.g. 100 meters to 1-meter transmission range) standards. Thus alternative wireless beacons, conforming to alternate wireless standards such as ZigBee and the like, may also be used. According to the invention, various types of RFID tags may also be used as well.

However, Bluetooth is often a preferred embodiment because handheld computerized devices are often equipped with Bluetooth transceivers (112).

As previously discussed, assume that each wireless beacon has its own beacon area (204) where the wireless beacon signals can be received. For omnidirectional wireless beacons, typically the beacon area may often be a roughly circular area (210) with the wireless beacon itself in the center, and the extent of this area will often be determined by a radius (212) from the wireless beacon (such as 202) that is roughly the length of the wireless transmission range. Thus, for example, using the standard formula for the area of a circle (πr²), an omnidirectional class 1 Bluetooth beacon may have a 100 meter radius (and a corresponding area of about 31,400 square meters), an omnidirectional class 2 Bluetooth beacon may have a 10 meter radius (and a corresponding area of about 314 square meters), and an omnidirectional class 3 Bluetooth beacon may have a 1 meter radius (and a corresponding area of about 3.14 square meters). Different types of beacons, such as directional wireless beacons with different shaped beacon areas, may also be used.

The extent of any given beacon field (230) may vary. In some embodiments, the beacon field may be a building or a portion of a building, and various human users, each holding their own handheld wireless devices (100a), may often wander about the building, occasionally coming within the detection range of various short range wireless beacons (201, 202, 203) within this larger beacon field (230). The beacon field need not be indoors, and further need not be contiguous—that is an operator may decide to designate multiple locations as each comprising part of the same beacon field.

Often, the various wireless beacons may be positioned near items or regions of interest (221, 222, 223), such as (for retail use) near certain store shelves holding various items of interest, or near various points of interest, so as to enable the user to use the system to immediately obtain large quantities of information about the various items. However such association with physical items is optional.

To make the invention easier to visualize, however, consider a use situation where a user holding a smartphone (100a) is walking throughout a beacon field comprising a retail building (store), and the various Bluetooth beacons (201, 202, 203), are here either class 2 (10 meter radius) or class 1 (1 meter radius) positioned by various shelves selling items of interest, such as item A (221), item B (222), and item C (223).

As previously discussed, according to the invention, for quick response times, the handheld computerized device (100a) will typically be configured to hold data associated with the various wireless beacons (201-203) in the beacon field (230) in a memory cache (240) in the device's memory (106). This memory cache (240) will thus comprise various data records (242) each linked to various wireless beacon identifiers (244).

FIG. 2 also shows how this information gets into the memory cache (240). Here, a handheld computerized device (100a) will typically be configured to monitor its location, and report its location, usually via a wireless link (250), and often using a computer network such as the internet (252), to a computer data server (254), here called the “record server”. As previously discussed, this computer data server can be a typical computer server with at least one processor, a network connection, operating system software, record search and retrieval software, and onboard server memory (256)

Typically the server memory 256 will comprise a database where various server stored data records (260), each associated with a server stored beacon identification (beacon ID 262), are further associated with one or more alternative beacon field identifiers (264). The record server search and retrieval software may be configured to use various types of beacon field identifiers as search keys to help determine which beacon ID and linked data records to retrieve. This can include the GPS location of the beacon field (230), and/or the identification codes for any WiFi access points serving the beacon field (230), and/or the beacon identification codes, such as UUID codes, for one or more known wireless beacons (e.g. any of 201, 202, or 203) known to be located within beacon field (230).

Typically device (100a), often when initially entering the beacon field (230) will wirelessly (e.g. by often by using the cellular transceiver 108 or WiFi transceiver 110) transmit information (264) pertaining to the device location (e.g. GPS location, and/or WiFi identification, and/or wireless beacon identification information) to the record server (254). Here assume that this location information comprises any of GPS location data, WiFi ID data, or wireless beacon data for beacon field F1 (230). The records server processor will check its database, determine that the device is located in beacon field F1, and determine that information is on file for beacon ID 01 (201), beacon ID 02 (202), and beacon ID 03 (203). The record server processor will retrieve this matching data (266), and transmit it back to the handheld computerized device (e.g. smartphone 100a). The smartphone software will direct its processor (102) to store this information (268) into the memory cache (240) in smartphone memory (106). There this data will be instantly available for use when needed.

Ways to Transmit Device Location Data to the Record Server (254):

As previously discussed, the device “location” can be determined by various methods, including GPS location, location relative to known WiFi access points, and location relative to known wireless beacons. Any of these methods can be then used by the record server (254) to determine the appropriate beacon field (230, 231) to then use to determine how best to pre-load the memory cache (240). These various methods will be discussed in more detail below.

GPS methods: In some embodiments, the at least one device transceiver can comprise a cellular network transceiver (108) and the device (100) can further comprise a GPS receiver (118). Here the invention can configure the device (100) (e.g. the device processor 102) to obtain the device location information from the GPS receiver (118), and to use at least the cellular network transceiver (108) (or optionally the WiFi transceiver 110 to transmit 250) information pertaining to the device location to the record server (254).

WiFi identification methods: In some embodiments, the at least one device transceiver can comprise a WiFi transceiver (110) configured (such as by using processor 102) to identify local WiFi access points (280), here assumed to cover the extent of the beacon field (230). For this embodiment, assume that at least some of the various wireless beacons are within the WiFi coverage area of at WiFi access point that can be identified by the device (100). This WiFi identification can use typical WiFi identification schemes, such as the WiFi's SSID (service set identifier) or other identification method. Thus in this scheme, the beacon field (e.g. 230, 231) can be alternatively defined by the identified WiFi access point (280). Here, for example, a WiFi access point may have a span of coverage of 300 feet or more (more if locally networked WiFi access points are used), and multiple wireless beacons, each with a beacon range of 0-3 feet, or 3 to 30 feet, can exist within the larger beacon field identified by the WiFi SSID or other identification method.

Thus, according to this embodiment, at the record server (254), at least some of the wireless beacon identifiers, and also their corresponding linked data records, are further associated with beacon fields defined by various identified WiFi access points. Put alternatively, in this scheme at least some of the plurality of data records linked to the wireless beacon identifiers are further associated with at least one identified WiFi access point. Note that this association between the identified WiFi access point, and a corresponding beacon field, can be done at either the server (254) or on the device (100) itself.

Here, in this embodiment, the invention can use the identified WiFi access point (280), the identified device WiFi transceiver, and any of the device processor and the record server processor, to identify when a device is within a WiFi coverage area of at least one identified WiFi access point, and using use this identification to determine the device location, at least with respect to finding the appropriate beacon field (230, 231).

Wireless beacon identification methods: In some embodiments, one or more wireless beacons may be used to inform the device (100) when it has entered a beacon field (230). Here, for example, in a building situation, certain “beacon field identifier” or “device location” wireless beacons may be placed at strategic locations (e.g. building entrances, elevators, and the like). These beacon field identifier wireless beacons may or may not have associated data records, since the main purpose is to establish a beacon field, rather than to deliver beacon associated data (although they may also do this as well if desired).

In this embodiment, the plurality of wireless beacons can further comprise at least one device location identifier wireless beacon configured to transmit its device location wireless beacon identifier. In this embodiment, the record server memory (256) will again store an association between the device location wireless beacon identifier and at least some other wireless beacons, but note here, as shown in FIG. 2 (264), this beacon identifier (here assume that this beacon identifier can be a portion of a UUID, such as the major significant UUID value) can also be used by the server (254) as an index or search key to look up an associated beacon field, and hence those wireless beacon identifiers associated with that beacon field.

In this embodiment, the invention can be configured to further use the device (100), and the at least one device location wireless beacon identifier, to identify this device location wireless beacon identifier, and transmit at least portions of the at least one device location wireless beacon identifier (such as the beacon Major value and UUID) to the record server (254) as information pertaining to the device location (264).

Regarding UUID, and major and minor wireless beacon values: The term “UUID” stands for Universally Unique Identifier. UUID, often comprise an identification number comprising 32 hexadecimal digits (or 128 bits). Wireless beacons often use such UUID as a beacon identification because this system has a large number of possible permutations. In addition to the UUID, some beacon standards, such as the iBeacon standard, also allow the user to optionally also assign Major and Minor beacon values to their wireless beacons as well. In the iBeacon standard, each major or minor beacon value can be an additional value between 0 and 65535.

Typically, the combination of the UUID and any major value is used to identify related beacons, such as those beacons assigned to a particular location, which in some embodiments can be the same as the invention's beacon field as well. By contrast, the combination of the UUID and any major value and any minor value can be used to identify specific individual beacons. Thus in some embodiments, the beacon field can be the combination of the beacon UUID and any major value, and the specific beacon ID can be the combination of the beacon UUID and any major value and any minor value. However, these specific embodiments and examples are not intended to be limiting.

FIG. 3 shows how the invention operates to almost instantly deliver information to a user whenever a smartphone or other handheld computerized device gets within range of a wireless beacon. In FIG. 3, the handheld computerized device (100b) is shown as now being within wireless reception range of beacon (201). The handheld computerized device receives the beacon identifier (“01”) associated with beacon (201), and uses its processor (102) and the received beacon identifier (here beacon ID 01) to search for (270) and retrieve (272) the data record linked to this particular received wireless beacon identifier. In this example, the beacon (201) is associated with item A (201), and at least a portion of the data record is a video giving information about item A (201). The handheld computerized device (100b) software is configured to play this video on the device's touchscreen or display screen (104).

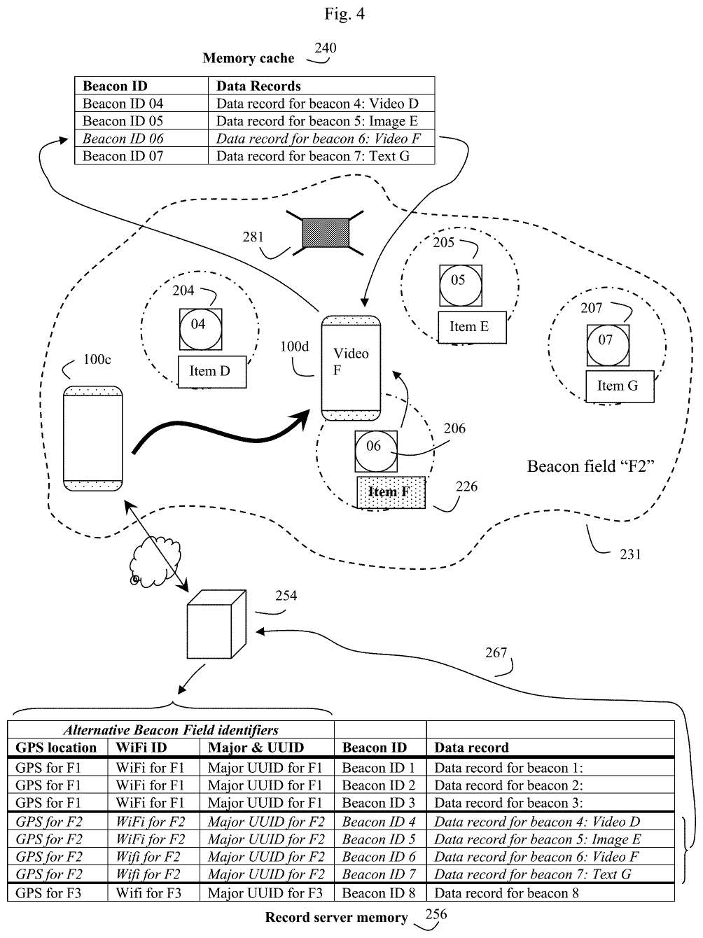

FIG. 4 shows how the invention can continue to operate when the user of the device (100c) now enters a different beacon field (231). This different beacon field (231) will often be in a different physical location (e.g. may have different GPS coordinates), may have a different WiFi access point (281), and will have different wireless beacons (204-207) as well.

As before, the handheld computerized device will transmit information pertaining to the device location to the record server. However this time, the device location is any of GPS, or WiFi identification data, or beacon identification data for the alternative beacon field “F2” (231). As a result, the server will retrieve a different set of information (267) from its database (256) that is relevant to wireless beacons (204, 205, 206, and 207), transmit this different set of information to the handheld computerized device (100c), which will store them in its memory cache (240).

Assume that after this step, the user now enters the beacon area local to the beacon (206), and the handheld computerized device local to the beacon (206) is now designated as the device (100d). Here, the device will use its Bluetooth transceiver, or other transceiver, (112) to pick up the wireless beacon identifier from (206) (here the wireless beacon identifier is just designated as “06”), and use its processor (102) to check its memory (106) and memory cache (240) for a corresponding data record linked to this beacon ID (here some of the data is a video for an item “F” 226 near the beacon 206). The system can then display the video for item F (226) on the device's touchscreen or display screen (104).

FIG. 5 shows a flow chart that further shows how the software onboard the handheld computerized device (100) and the record server (254) may operate. Here, as previously discussed in FIG. 2, device (100) may use its software and processor (102) to receive device location data for a particular beacon field, such as GPS data from its GPS receivers (118), local WiFi identification codes from its WiFi transceiver (110), or beacon identification data from its Bluetooth or other beacon transceiver (112), and use its cellular transceiver (108) or WiFi transceiver (110) transmit this device location data (and thus beacon field data) to the record server (254).

The record server (254) will use its processor and record matching software, as well the received location data, and determine if there are any matching beacon field records corresponding to the device location in the server memory (256). If so, the record server will send any data records that match the beacon field location data to the memory cache (240) in the memory of the handheld computerized device (100). Regardless of the outcome, the record server will then keep looking for additional device location data, and continue trying to determine if there are matching data records.

As previously described in FIG. 3, the handheld computerized device (100) software and processor (102) will then receive any beacon identifiers (usually from Bluetooth transceiver (112) and use the beacon ID and the beacon ID linked data records in the memory cache (240) to retrieve the relevant data records linked to the latest received beacon ID, and usually display at least portions of this data (e.g. video, graphics, text) on the touchscreen (104) of the handheld computerized device (100).

Additionally, as will be discussed, the handheld computerized device (100) can do other operations with portions of the data. In some embodiments, the device can be configured (at least occasionally or partially by the beacon linked data itself), to receive various types of user input (e.g. touchscreen touch data, accelerometer motion sensing data, sound, button presses). The device may be further configured to transmit at least some of this user input data back to the record server (254) (or other input data recipient) for storage and/or further analysis.

Cleaning the Memory Cache:

Handheld computerized devices have a finite amount of memory, and at some point, it may be useful to clear the memory cache (240) in memory (106) so as to make room for beacon data from different locations, update beacon data, or to release memory for other purposes. This can be done according to various schemes.

In some embodiments, the memory cache (240) data records linked to the wireless beacon identifiers can be further associated with a time stamp according to the time of their acquisition. This time stamp can be applied by either the device processor (102) or the record server processor. In this embodiment, the device processor (102) may be configured to delete at least those data records linked to wireless beacon identifiers according to any of

a) Those data records that are also associated with a time stamp that exceeds a pre-determined time threshold.
b) Those data records linked to wireless beacon identifiers that are no longer detected by the device after a pre-determined time threshold.
c) Those data records linked to wireless beacon identifiers that are also associated with a location that differs from the device location by a pre-determined amount. Here, for example, if the first set of wireless beacon identifiers is identified with a first beacon field (230), and the system is now detecting that the device is now in a second beacon field (231), then the pre-determined amount of location may be exceeded, and the beacons and associated data associated with beacon field (230) now deleted.

More sophisticated methods, such as having the system recognize that different locations or beacon fields are located near each other (e.g. be different stores in a mall) may also be employed to reduce the amount of “thrashing” or useless deletion or reloading if the user is going back and forth between closely associated locations or beacon fields.

Displaying Beacon Linked Data in a Dynamic (Time-Varying) or Interactive Manner:

In some embodiments, the invention may further configure the system to, in addition to displaying time-varying beacon associated data records such as video files and/or audio files on the handheld computerized device (100), to also display other types of text or graphic information in a dynamic or interactive manner.

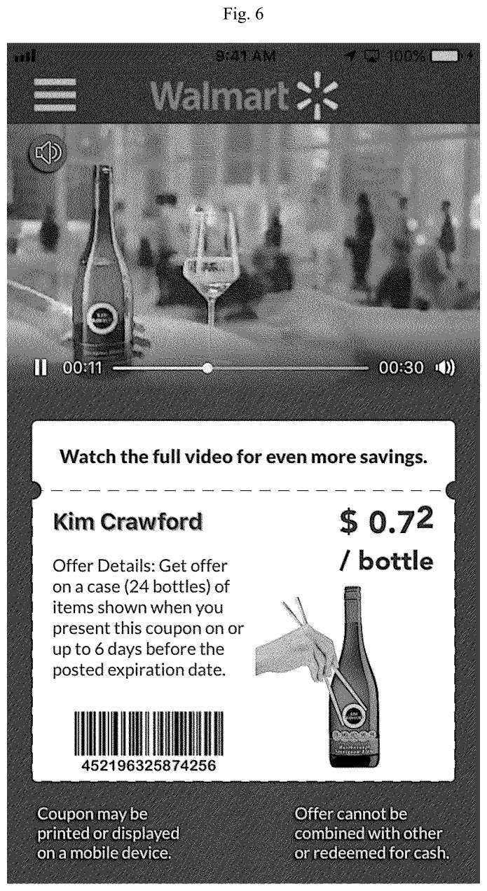

FIG. 6 shows an example of the invention's display screen, which also gives an example of how the system can display data records in a dynamic and interactive manner. Here assume that the system has previously detected that it is in a beacon field (230) associated with one or more Walmart stores, and may have thus configured its display accordingly. Here further assume that, as per FIG. 3, the device is near a wine display (that is, item A 221 is a wine display). Here the system has retrieved a video advertisement for a particular wine, and is also showing a time variable coupon for this particular wine. The device is waiting for user input. For example, the system may have activated a time stamp when the data record was initially displayed and is here using its device processor (102) to increment a parameter (a particular price discount, or larger value coupon) as elapsed time grows. Here, the time variable coupon value can be used as a reward to encourage the user to watch the video to the end.

Put alternatively, in some embodiments, the invention can configure the device processor (102) to display both at least some data from retrieved data records and a timer on the GUI (104). This timer can, for example, report data (such as a time variable price discount) pertaining to the elapsed time since a latest retrieved data record was initially displayed on the device's GUI. In some embodiments, the invention can also configure the device processor to receive user input (such as a touch of the user's finger) from the GUI, along with data pertaining to the elapsed time. The system can also configure the device processor to transmit at least the received user input and data pertaining to the elapsed time to an internet server, which may in some embodiments also be the record server (254). Here, for example, the system may keep track of when the user interacted with the video, and/or how long the use watched the video, and transmit this information to the server (254).

More specifically, in this embodiment, at least some data from retrieved data records can include at least one parameter such as a price discount parameter. Here the system can use either the device processor and/or the record server processor to increase or decrease this at least one parameter according to the elapsed time. Thus, for example, the value of the coupon or other type value could increase or decrease with time.

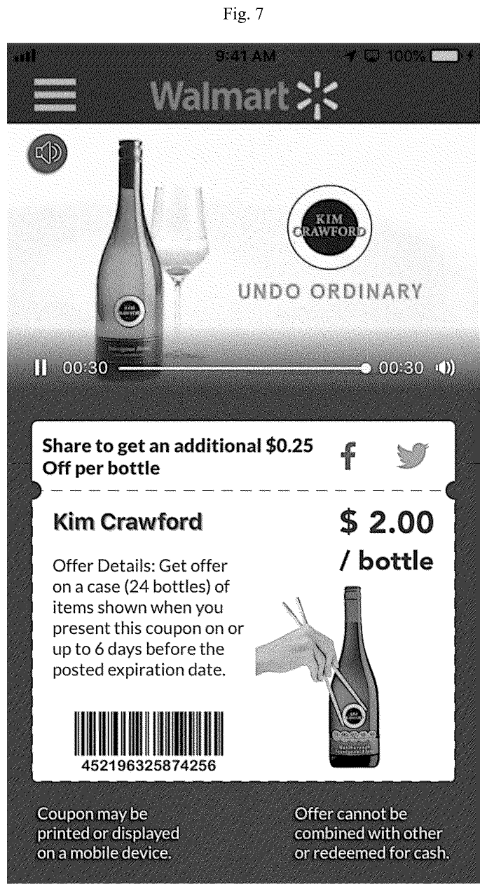

FIG. 7 shows that the video commercial is now nearly done, and the elapsed time has incremented still further. The value of the price discount has been incremented still higher as a reward for the user to watch the entire video.

Methods of Handling User Input:

The invention may be configured to receive user input from the computerized device (100), and handle it in various ways. Here, for example, according to the invention, the system may further use the device processor (102), and user input received from the GUI (104), to further perform any of:

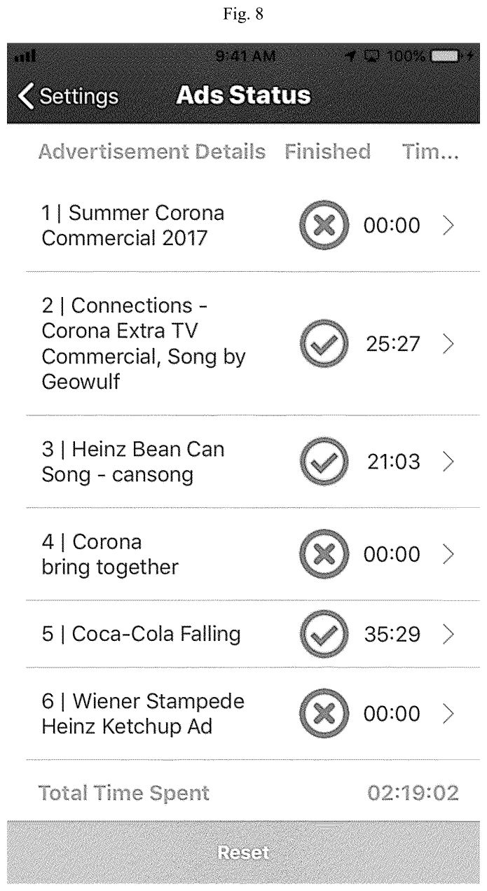

a) Storing at least some data from the retrieved data records in a separate non-cache portion of the device memory (106).
b) Hold and continue to display the at least some data from retrieved data records on the GUI screen (104) until further user input.
c) Transmit at least some data from the retrieved data records to an outside device (for example, the user might press a virtual button on the GUI to direct the device (100) to send wireless signals to print out a coupon on a printer configured to receive wireless signals).
d) Transmit at least some data from the retrieved data records, and at least some user input received from the GUI, to an internet server. This could be the record server (254) or other internet server. This internet server will typically comprise an internet server database. According to the invention, this internet server can be configured to store at least some of the user input, and at least some data from the retrieved data records, in the internet server's database. This data can then be processed and further analyzed (e.g. statistically analyzed), as desired. One example of this is shown in FIG. 8.

The system can also be configured to take various actions, which may be configured differently for each wireless beacon. In some cases, the system can be configured to award something of value when actions are taken. For example, pressing a GUI displayed “post to Facebook” or “Tweet” button could increase the value of a coupon, effectively paying the user to complete the action. The system could also be configured so that a user could press a GUI displayed ‘thumbs up or down’ button to provide feedback to the brand or establishment. Additionally, the system could be configured so that if the user purchases a predetermined combination or quantity of products; additional benefits, discounts, or compensation could automatically be provided by the system.

In some embodiments, the data records can comprise one or more coupons that can be displayed by using a customized background unique to the advertiser, and the overlaying static images may reuse certain graphical elements.

In some embodiments, if the data record is for a coupon, after the coupon is displayed, the system can be configured to enable the user to perform any of: placing this coupon into an app wallet, emailing the coupon to the user, printing the coupon, transmitting the coupon to another system, or placing the coupon into another (different) wallet app.

In some embodiments, the data records can comprise bar codes, enabling the coupons displayed on the device to be scanned by a bar code reader. In some embodiments, the device (100) may be configured to display coupons one at a time with the user advancing to the next item; or displayed automatically with the coupons automatically advancing so that the various coupons can be scanned in mass without intervention. Alternatively, the record server (254) or device (100) may be configured so that coupons can be sent directly to a user's “loyalty account” which would provide for automatic redemption and possible future storage.

### Other Embodiments

In addition to user input on the GUI (104), other types of user input can also be received and processed by the system as well. For example, in some embodiments, it may be useful to track when the user has reacted to beacon associated data by moving or shaking the handheld computerized device (100). This information can be processed by also configuring the device processor (102) to monitor the movement of the device (100), at least after certain beacons and certain types of beacon associated data are received. This can be done by using motion data from the device's accelerometer or other motion sensor (116).

In some embodiments, for example, the device (100) will typically further comprise at least one accelerometer or other motion sensor (116) and at least one haptic transducer (114). The haptic transducer will typically vibrate or cause the device to twitch somewhat in response to signals from the processor (102). In this embodiment, the device processor can be configured to use the haptic transducer (114) to produce at least a transient haptic output when the processor detects that it has received a signal from a wireless beacon that the device (100) processor knows has a corresponding wireless beacon ID in the memory cache (240).

For example, the processor may be triggered to produce a haptic output when it receives at least some wireless beacon identifiers that correspond to the wireless beacon identifiers with data records that are already in memory cache, (240). Alternatively, the processor may just display at least some of the data from retrieved data records the GUI without triggering the haptic transducer. In either case, the device processor can be further configured to then use the at least one accelerometer to determine what type of motion data associated with user movement of the device has occurred either after the initial vibration or after the data was displayed.

For example, assume that the users normally walk with their devices (100) in their pockets. This type of accelerometer monitoring can let the system operator know, for example, if the users tend to ignore certain beacons altogether (e.g. walk by certain displays even if the display has a wireless beacon, and the device (100) vibrates). This can also let the system operator know if the user tends to hold the device in an unusual manner (indicating interest, or lack thereof) while any video or other data associated with a particular wireless beacon is being displayed on the GUI.

Examples of such user behavior data can include overall statistics such as:
How many times the phone vibrated or played an alert for a nearby beacon
How many times the phone was picked up
How long the delay was before the phone was picked up

Beacon or product specific statistics can also be obtained. For example, assume here that the data record was for a video advertisement for a particular product. Statistics can be obtained such as:
How long was the video (ad) was watched before stopped (if it was)
Was the phone placed back in the pocket or purse before viewing the entire video (ad)
Were any buttons pressed on the phone during the time the video (ad) was playing (e.g. volume, rewind, screen tapped, etc.)? Which buttons, and when?
What percentage and length of the video (ad) was watched

FIG. 8 shows a simple example of the type of statistical analysis that may be done by the system. Here the various wireless beacon linked data records (here various ads, songs, and videos) are ranked according to various criteria.

In other cases, when the data record is for a coupon or video ad for a particular product, the system might accumulate additional information such as:
Was a Facebook icon clicked, and how long into the video (ad) did that happen?
Was a Twitter icon clicked, and how long into the video (ad) did that happen?
In the case of a time variable parameter, such as a coupon value, what was the starting and ending coupon value when the video (ad) was playing?
Which social media icon (e.g. Twitter or Facebook) did the user clicked first?
What was the time interval between any clicking of both a Facebook icon and a Twitter icon?

Statistical data can then be made available for each coupon, aggregated over a plurality of icons, and the like.

Bluetooth® is a trademark of the Bluetooth Special Interest Group (SIG).

1. A method of delivering data to a graphical user interface (GUI) of a handheld computerized device, said method comprising:
transmitting, using a plurality of wireless beacons, each disposed at a beacon location within a beacon field, each comprising a beacon short-range wireless transmitter, a wireless beacon identifier to beacon areas local to each said beacon location;
receiving, using said device, said wireless beacon identifiers when said device has a device location that is within said beacon areas;
wherein said device comprises a device processor, device memory; at least one device transceiver; and a GUI;
wherein said device memory comprises a memory cache comprising a first plurality of data records linked to said wireless beacon identifiers;
retrieving, using said device processor and received wireless beacon identifiers, those data records linked to said received wireless beacon identifiers, and displaying at least some data from retrieved data records on said GUI.

2. The method of claim 1, further transmitting, using said device, information pertaining to its device location to a record server, said record server comprising a record server processor and record server memory;
said record server memory comprising a second plurality of data records linked to said wireless beacon identifiers;
said second plurality of data records linked to said wireless beacon identifiers and said wireless beacon identifiers are further linked according to their beacon field;
matching, using said record server processor, said information pertaining to said device location with said beacon field, and using matches to control transmitting, using said record server processor, of any matching data records and linked wireless beacon identifiers to said device; and
storing, using said device processor, at least some data records and linked wireless beacon identifiers in said memory cache.

3. The method of claim 2, wherein said at least one device transceiver comprises a cellular network transceiver, said device further comprises a GPS receiver; and
said device uses device location information from said GPS receiver to transmit, using said cellular network transceiver, information pertaining to its device location to said record server.

4. The method of claim 2, wherein said at least one device transceiver comprises an identified device WiFi transceiver; and
wherein at least some of said plurality of wireless beacons are within a WiFi coverage area of at least one identified WiFi access point;
wherein at least some of said plurality of data records linked to said wireless beacon identifiers are further associated with said at least one identified WiFi access point;
identifying, using said identified WiFi access point, said identified device Wifi transceiver, and any of said device processor and said record server processor, when said at least one device is within a WiFi coverage area of said at least one identified WiFi access point, and using said identification to determine said device location.

5. The method of claim 2, wherein said plurality of wireless beacons further comprises at least one device location identifier wireless beacon configured to transmit its device location wireless beacon identifier;
said record server memory stores an association between said device location wireless beacon identifier and at least some other wireless beacons;
further receiving, using said device, said at least one device location wireless beacon identifier, and transmitting at least portions of said at least one device location wireless beacon identifier to said record server as information pertaining to said device location.

6. The method of claim 1, wherein said data records linked to said wireless beacon identifiers are further associated with a time stamp according to time of their acquisition;
further deleting, using said device processor, at least those data records linked to wireless beacon identifiers according to any of
a) those data records that are also associated with a time stamp that exceeds a pre-determined time threshold;
b) those data records linked to wireless beacon identifiers that are no longer detected by said device after a pre-determined time threshold;
c) those data records linked to wireless beacon identifiers that are also associated with a location that is differs from said device location by a pre-determined amount.

7. The method of claim 1, further displaying, using said device processor, both at least some data from retrieved data records and a timer on said GUI;
said timer reporting data pertaining to elapsed time since a latest retrieved data record was initially displayed on said GUI;
using said device processor to receive user input from said GUI, along with data pertaining to said elapsed time; and
using said device processor to transmit said at least said received user input and data pertaining to said elapsed time to an internet server.

8. The method of claim 7, wherein said at least some data from retrieved data records include at least one parameter; and
using any of said device processor and a record server processor to increase or decrease said at least one parameter according to said elapsed time.

9. The method of claim 1, wherein said device further comprises at least one accelerometer and at least one haptic transducer;
further using said device processor and said haptic transducer to produce at least a transient haptic output triggered by receiving at least some wireless beacon identifiers with data records in said memory cache, or displaying at least some data from retrieved data records on said GUI; and/or
further determining, using said device processor and said at least one accelerometer, what type of motion data associated with user movement of said device has occurred.

10. The method of claim 1, further using said device processor, and user input received from said GUI, to further perform any of:
a) store at least some data from said retrieved data records in a separate non-cache portion of said device memory;
b) hold and continue to display said at least some data from retrieved data records on said GUI until further user input;
c) transmit at least some data from said retrieved data records to an outside device.
d) transmit at least some data from said retrieved data records, and at least some user input received from said GUI, to an internet server comprising an internet server database, and using said internet server to store at least some of said user input, and at least some data from retrieved data records, in said internet server database.

11. The method of claim 1, wherein said beacon short-range wireless transmitter comprises any of an RFID transmitter, a Bluetooth wireless transmitter, or a transmitter portion of a Bluetooth wireless transceiver.

12. A method of delivering data to a graphical user interface (GUI) of a handheld computerized device, said method comprising:
transmitting, using a plurality of wireless beacons, each disposed at a beacon location within a beacon field, each comprising a beacon short-range wireless transmitter, a wireless beacon identifier to beacon areas local to each said beacon location;
receiving, using said device, said wireless beacon identifiers when said device has a device location that is within said beacon areas;
wherein said device comprises a device processor, device memory; at least one device transceiver; and a GUI;
wherein said device memory comprises a memory cache comprising a first plurality of data records linked to said wireless beacon identifiers;
retrieving, using said device processor and received wireless beacon identifiers, those data records linked to said received wireless beacon identifiers, and displaying both at least some data from retrieved data records on said GUI and a timer on said GUI;
said timer reporting data pertaining to elapsed time since a latest retrieved data record was initially displayed on said GUI;
using said device processor to receive user input from said GUI, along with data pertaining to said elapsed time; and
using said device processor to transmit said at least said received user input and data pertaining to said elapsed time to an internet server;
wherein said at least some data from retrieved data records include at least one parameter; and
using any of said device processor and a record server processor to increase or decrease said at least one parameter according to said elapsed time.

13. The method of claim 12, further transmitting, using said device, information pertaining to its device location to a record server, said record server comprising a record server processor and record server memory;
said record server memory comprising a second plurality of data records linked to said wireless beacon identifiers;
said second plurality of data records linked to said wireless beacon identifiers and said wireless beacon identifiers are further linked according to their beacon field;
matching, using said record server processor, said information pertaining to said device location with said beacon field, and using matches to control transmitting, using said record server processor, of any matching data records and linked wireless beacon identifiers to said device; and
storing, using said device processor, at least some data records and linked wireless beacon identifiers in said memory cache; wherein any of:
a) said at least one device transceiver comprises a cellular network transceiver, said device further comprises a GPS receiver; and
said device uses device location information from said GPS receiver to transmit, using said cellular network transceiver, information pertaining to its device location to said record server;
b) said at least one device transceiver comprises an identified device WiFi transceiver; and
wherein at least some of said plurality of wireless beacons are within a WiFi coverage area of at least one identified WiFi access point;
wherein at least some of said plurality of data records linked to said wireless beacon identifiers are further associated with said at least one identified WiFi access point;
identifying, using said identified WiFi access point, said identified device Wifi transceiver, and any of said device processor and said record server processor, when said at least one device is within a WiFi coverage area of said at least one identified WiFi access point, and using said identification to determine said device location;
c) wherein said plurality of wireless beacons further comprises at least one device location identifier wireless beacon configured to transmit its device location wireless beacon identifier;
said record server memory stores an association between said device location wireless beacon identifier and at least some other wireless beacons;
further receiving, using said device, said at least one device location wireless beacon identifier, and transmitting at least portions of said at least one device location wireless beacon identifier to said record server as information pertaining to said device location.

14. The method of claim 12, wherein said device further comprises at least one accelerometer and at least one haptic transducer;
further using said device processor and said haptic transducer to produce at least a transient haptic output triggered by receiving at least some wireless beacon identifiers with data records in said memory cache, or displaying at least some data from retrieved data records on said GUI; and/or
further determining, using said device processor and said at least one accelerometer, what type of motion data associated with user movement of said device has occurred.

15. The method of claim 12, further using said device processor, and user input received from said GUI, to further perform any of:
a) store at least some data from said retrieved data records in a separate non-cache portion of said device memory;
b) hold and continue to display said at least some data from retrieved data records on said GUI until further user input;
c) transmit at least some data from said retrieved data records to an outside device.
d) transmit at least some data from said retrieved data records, and at least some user input received from said GUI, to an internet server comprising an internet server database, and using said internet server to store at least some of said user input, and at least some data from retrieved data records, in said internet server database.

16. A system for delivering data to a graphical user interface (GUI) of a handheld computerized device, said system comprising:
a plurality of wireless beacons, each disposed at a beacon location within a beacon field, each comprising a beacon short-range wireless transmitter, each configured to transmit a wireless beacon identifier to beacon areas local to each said beacon location;
a handheld computerized device a device processor, device memory; at least one device transceiver; and a GUI;
wherein said device memory further comprises a memory cache comprising a first plurality of data records linked to said wireless beacon identifiers;
said device configured to use said at least one device transceiver and said device processor to receive said wireless beacon identifiers when said device has a device location that is within said beacon areas;
said device further configured to retrieve, using said device processor and received wireless beacon identifiers, those data records linked to said received wireless beacon identifiers, and displaying at least some data from retrieved data records on said GUI.

17. The system of claim 16, wherein said device is further configured to transmit information pertaining to its device location to a record server, said record server comprising a record server processor and record server memory;
said record server memory comprising a second plurality of data records linked to said wireless beacon identifiers;
said second plurality of data records linked to said wireless beacon identifiers and said wireless beacon identifiers are further linked according to their beacon field;
record server processor configured to match said information pertaining to said device location with said beacon field-, and using matches to control transmitting of any matching data records and linked wireless beacon identifiers to said device; and
said device processor configured to store at least some data records and linked wireless beacon identifiers in said memory cache.

18. The system of claim 16, wherein said device processor is further configured to display both at least some data from retrieved data records and a timer on said GUI;
said processor configured to produce timer reporting data pertaining to elapsed time since a latest retrieved data record was initially displayed on said GUI;
said device processor further configured to receive user input from said GUI, along with data pertaining to said elapsed time; and
said device processor further configured to transmit said at least said received user input and data pertaining to said elapsed time to an internet server.

19. The system of claim 18, wherein said at least some data from retrieved data records include at least one parameter; and
wherein any of said device processor and a record server processor are configured to increase or decrease said at least one parameter according to said elapsed time.

20. The system of claim 16, wherein said beacon short-range wireless transmitter comprises any of an RFID transmitter, a Bluetooth wireless transmitter, or a transmitter portion of a Bluetooth wireless transceiver.
